(19) United States
(12) Patent Application Publication
(10) Pub. No.: US 2016/0327828 A1
(43) Pub. Date: Nov. 10, 2016

(54) LIQUID CRYSTAL DISPLAY DEVICE

(71) Applicant: Japan Display Inc., Minato-ku (JP)

(72) Inventor: Youichi ASAKAWA, Minato-ku (JP)

(73) Assignee: Japan Display Inc., Minato-ku (JP)

(21) Appl. No.: 15/143,688

(22) Filed: May 2, 2016

(30) Foreign Application Priority Data
May 8, 2015 (JP) 2015-095713

(51) Int. Cl. G02F 1/1333; G02F 1/1337; G02F 1/1343

(52) U.S. Cl. CPC G02F 1/133345; G02F 1/134309; G02F 1/1337

(57) ABSTRACT

A liquid crystal display device includes an insulating film that includes a first insulating film formed between a first and second electrodes and a second insulating film formed between a liquid crystal alignment film and the second electrode; Letting d1 denote a film thickness of the first insulating film, ∈1 denote relative permittivity of a material of the first insulating film, d2 denote a film thickness of the second insulating film, ∈2 denote relative permittivity of a material of the second insulating film, and ca denote a chevron angle of liquid crystals, the liquid crystal display device satisfies expression (1) and either one of expressions (2) and (3) given below.

9<∈1<65 (1)

∈1/d1>∈2/d2 (2)

10°<ca (3)

### CROSS-REFERENCE TO RELATED APPLICATIONS

This application claims priority from Japanese Application No. 2015-095713, filed on May 8, 2015, the contents of which are incorporated by reference herein in its entirety.

### BACKGROUND

1. Technical Field

The present disclosure relates to a liquid crystal display device.

2. Description of the Related Art

In a liquid crystal display device working in a fringe field switching (FFS) mode that is a form of a transverse electric field mode, a liquid crystal alignment film, a first electrode, a capacitor insulating film, and a second electrode are arranged in this order from a side of liquid crystals. The first and second electrodes partially face each other with the capacitor insulating film interposed therebetween. The portion where the first and second electrodes face each other serves as a storage capacitor. In the portion where the first and second electrodes do not face each other, an electric field is generated across a region from the second electrode through the capacitor insulating layer and the liquid crystals to the first electrode. This electric field controls orientations of the liquid crystals.

Letting C1, C2, and C3 denote capacitance components of the capacitor insulating film, the liquid crystal alignment film, and the liquid crystals, respectively, along the electric field, the total capacitance component including the capacitance components C1, C2, and C3 serves as a capacitance component between the first and second electrodes. A voltage between the first and second electrodes is divided at a capacitance ratio of the capacitance components C1, C2, and C3. The voltage applied to the liquid crystals varies with variation in the capacitance ratio. The variation in the capacitance ratio is mainly caused by uneven film thickness of the liquid crystal alignment film. This is because film thickness of the liquid crystal alignment film is very small, and slight unevenness of the film thickness greatly varies the capacitance component C2 of the liquid crystal alignment film. In particular, when relative permittivity of the capacitor insulating film is increased to increase the storage capacitance, the voltages divided between the liquid crystal alignment film and the liquid crystals increase. Consequently, the voltage applied to the liquid crystals is likely to greatly vary.

### SUMMARY

A liquid crystal display device according to an aspect of the present invention includes an insulating base substrate; an insulating film formed on the insulating base substrate; a first electrode; a second electrode that forms an electric field together with the first electrode therebetween; liquid crystals; and a liquid crystal alignment film that aligns the liquid crystals. The insulating film includes a first insulating film formed between the first and second electrodes, and a second insulating film formed between the liquid crystal alignment film and the second electrode. The second insulating film is formed so as not to overlap the first electrode. The first electrode is placed closer to the liquid crystals than the second electrode. Letting d1 denote a film thickness of the first insulating film, ∈1 denote relative permittivity of a material of the first insulating film, d2 denote a film thickness of the second insulating film, ∈2 denote relative permittivity of a material of the second insulating film, and ca denote a chevron angle of the liquid crystals, the liquid crystal display device satisfies expression (1) and either one of expressions (2) and (3) given below.

9<∈1<65 (1)

∈1/d1>∈2/d2 (2)

10°<ca (3)

### BRIEF DESCRIPTION OF THE DRAWINGS

FIG. 1 is a plan view illustrating a configuration of a sub-pixel of a liquid crystal display device according to a first embodiment of the present invention;

FIG. 2 is a sectional view along line II-II′ of FIG. 1;

FIG. 3 is a schematic diagram for explaining a configuration of the vicinity of a first electrode and a second electrode;

FIG. 4 is an equivalent circuit diagram between the first and second electrodes;

FIG. 5 is a sectional view illustrating an example of a configuration of an insulating film;

FIG. 6 is a sectional view of a liquid crystal display device according to a second embodiment of the present invention;

FIG. 7 is a sectional view of a liquid crystal display device according to a third embodiment of the present invention;

FIG. 8 is a sectional view of a liquid crystal display device according to a fourth embodiment of the present invention;

FIG. 9 is a sectional view of a liquid crystal display device according to a fifth embodiment of the present invention;

FIG. 10 is a diagram for explaining a method for forming the insulating film;

FIG. 11 is a diagram illustrating a chevron angle in a liquid crystal display device according to a sixth embodiment of the present invention;

FIG. 12 is another diagram illustrating the chevron angle in the liquid crystal display device according to the sixth embodiment;

FIG. 13 is a diagram illustrating a relation between a voltage applied to liquid crystals and transmittance thereof (V-T curve);

FIG. 14 is a diagram illustrating changes in the V-T curve caused by changes in film thickness of a first liquid crystal alignment film and in the chevron angle;

FIG. 15 is a diagram illustrating a relation between a change amount of the transmittance caused by a film thickness variation (by an amount of 5 nm) in the first liquid crystal alignment film and the chevron angle;

FIG. 16 is a diagram illustrating relative permittivity values and band gaps of various materials; and

FIG. 17 is a diagram illustrating experimental examples concerning an intermittent driving evaluation and a streak evaluation.

### DETAILED DESCRIPTION

The following describes details of embodiments for carrying out the present invention, using the drawings. The present invention is not limited to the description of the embodiments to be given below. Components to be described below include a component or components that is/are easily conceivable by those skilled in the art or substantially the same component or components. Moreover, the components to be described below can be appropriately combined. The disclosure is merely an example, and the present invention naturally encompasses an appropriate modification maintaining the gist of the invention that is easily conceivable by those skilled in the art. To further clarify the description, a width, a thickness, a shape, and the like of each component may be schematically illustrated in the drawings as compared with an actual aspect. However, this is merely an example, and interpretation of the invention is not limited thereto. The same element as that described in the drawing that has already been discussed is denoted by the same reference numeral through the description and the drawings, and detailed description thereof will not be repeated in some cases where appropriate.

### First Embodiment

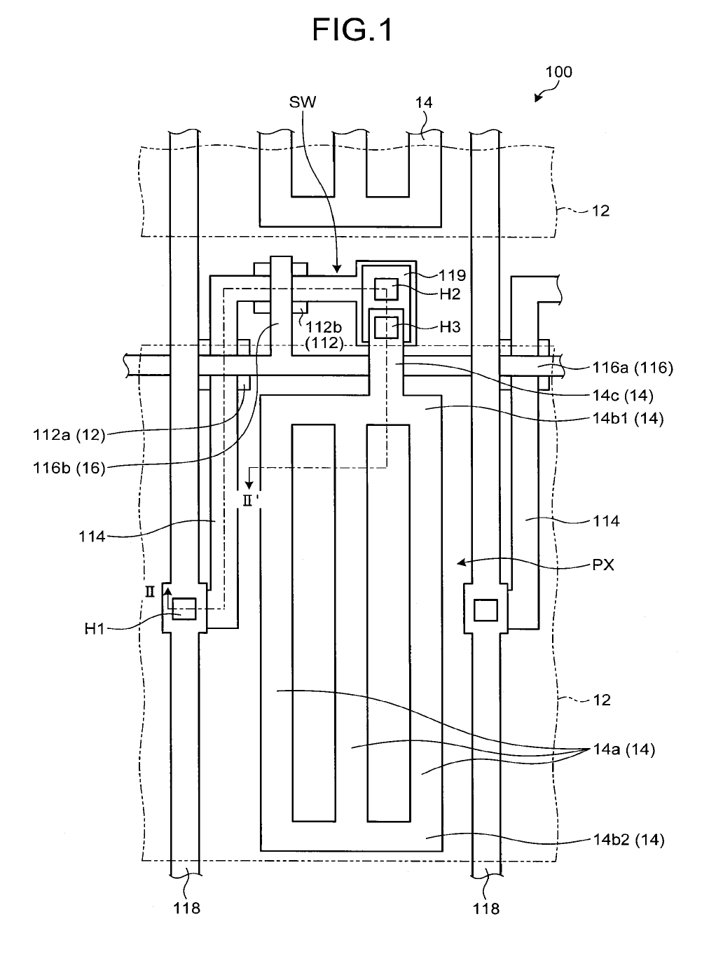

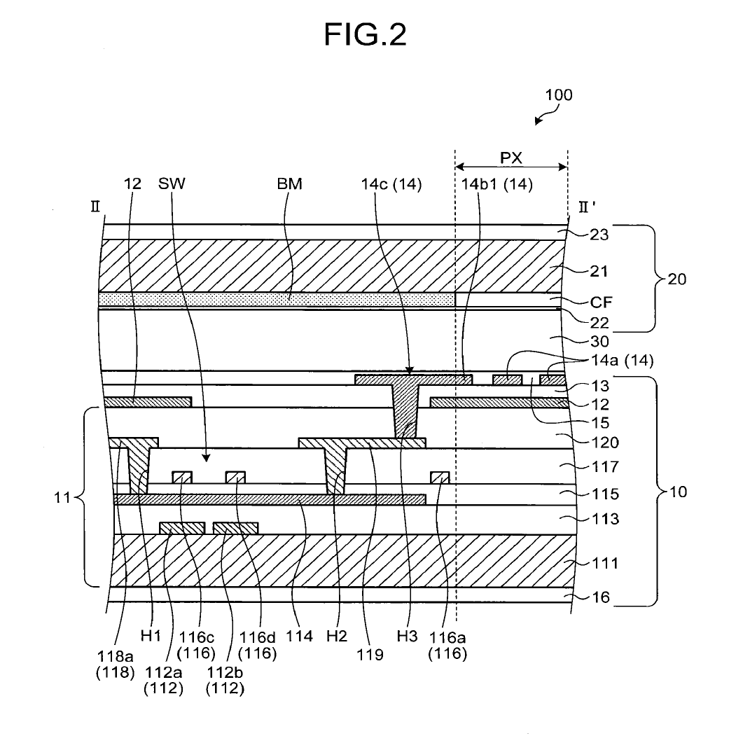

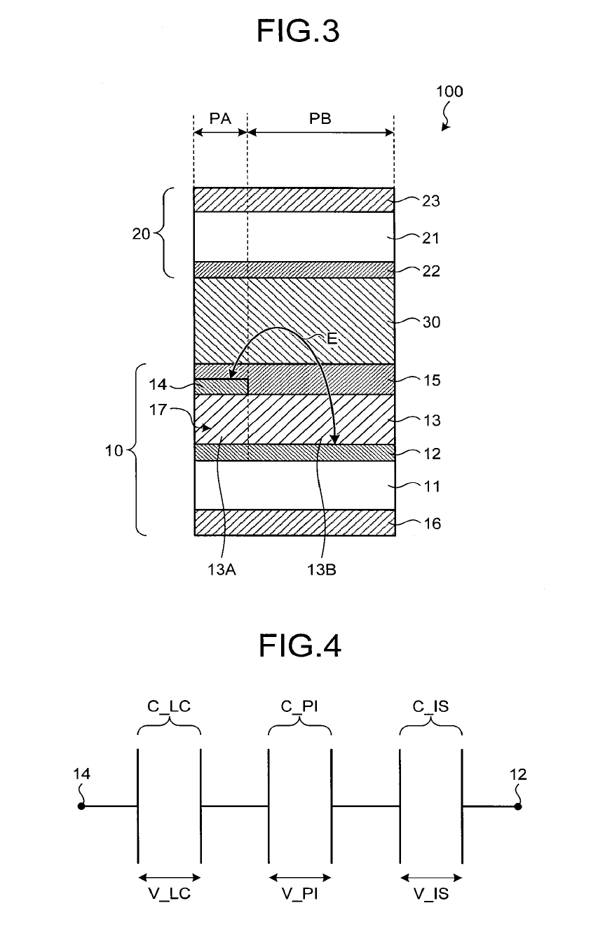

FIG. 1 is a plan view illustrating a configuration of a sub-pixel of a liquid crystal display device 100 according to a first embodiment of the present invention. FIG. 2 is a sectional view along line II-II′ of FIG. 1. FIG. 3 is a schematic diagram for explaining a configuration of the vicinity of a first electrode 14 and a second electrode 12.

As illustrated in FIGS. 2 and 3, the liquid crystal display device 100 is an FFS mode liquid crystal display device. The liquid crystal display device 100 includes a first substrate 10, a second substrate 20, and liquid crystals 30. The second substrate 20 is placed opposite to the first substrate 10. The liquid crystals 30 are interposed between the first substrate 10 and the second substrate 20. The liquid crystals 30 are made of, for example, a liquid crystal material having a negative dielectric constant anisotropy value (negative liquid crystal material), but may be made of a liquid crystal material having a positive dielectric constant anisotropy value (positive liquid crystal material).

The first substrate 10 includes a first insulating base substrate 11, an insulating film 13, the first electrode 14, the second electrode 12, a first liquid crystal alignment film 15, and a first polarizing plate 16. The first insulating base substrate 11 is provided with a circuit layer to apply a voltage for image display between the first and second electrodes 14 and 12. The circuit layer is provided with, for example, a scanning line 116, an image signal line 118, and a thin-film transistor SW each electrically coupled to the first electrode 14 or the second electrode 12.

The circuit layer is formed, for example, by stacking a light shielding layer 112, a first interlayer insulating layer 113, a semiconductor layer 114, a gate insulating layer 115, the scanning line 116, a second interlayer insulating layer 117, the image signal line 118, a drain electrode 119, and a third interlayer insulating layer 120 in this order on a translucent base substrate portion 111 made of glass or the like.

The liquid crystal display device 100 is driven in a normal driving mode for refreshing an image at 60 Hz, and also in a low-frequency driving mode for refreshing the image at a frequency lower than 60 Hz. In the low-frequency driving mode, the liquid crystal display device 100 is driven, for example, at a frequency of 30 Hz or lower, or preferably at a frequency of 10 Hz or lower.

The first electrode 14 is placed closer to the liquid crystals 30 than the second electrode 12. The second electrode 12 is formed, for example, on the first insulating base substrate 11. The insulating film 13 is formed on the first insulating base substrate 11 so as to cover the second electrode 12. The first electrode 14 is formed on the insulating film 13. The first electrode 14 partially overlaps the second electrode 12. The first liquid crystal alignment film 15 is formed on the insulating film 13 so as to cover the first electrode 14. The first liquid crystal alignment film 15 is subjected to an alignment treatment by rubbing or ultraviolet radiation. The first liquid crystal alignment film 15 aligns the liquid crystals 30 in a direction (initial alignment direction) set by the alignment treatment. The first polarizing plate 16 is bonded onto an outer surface of the first insulating base substrate 11 (surface opposite to a side thereof facing the liquid crystals 30).

The second substrate 20 includes a second insulating base substrate 21, a color filter CF, a light shielding layer BM, a second liquid crystal alignment film 22, and a second polarizing plate 23. The second liquid crystal alignment film 22 is formed on the second insulating base substrate 21 with the color filter CF and the light shielding layer BM interposed between the second insulating base substrate 21 and the second liquid crystal alignment film 22. The second liquid crystal alignment film 22 is subjected to the alignment treatment by rubbing or ultraviolet radiation. The second liquid crystal alignment film 22 aligns the liquid crystals 30 in a direction (initial alignment direction) set by the alignment treatment. The second polarizing plate 23 is bonded onto an outer surface of the second insulating base substrate 21 (surface opposite to a side thereof facing the liquid crystals 30).

The transmission axes of the first and second polarizing plates 16 and 23 are orthogonal to each other. The directions of the alignment treatment (for example, the rubbing directions) of the first and second liquid crystal alignment films 15 and 22 are equal to each other. The directions of the alignment treatment of the first and second liquid crystal alignment films 15 and 22 are parallel to the transmission axes of the first polarizing plate 16 or the transmission axes of the second polarizing plate 23.

The liquid crystal display device 100 includes a first region PA in which the first electrode 14 overlap the second electrode 12 and a second region PB in which the first electrode 14 does not overlap the second electrode 12. A portion of overlapping of the first and second electrodes 14 and 12 with the insulating film 13 interposed therebetween serves as a capacitive element 17. A voltage applied between the first and second electrodes 14 and 12 is held by the capacitive element 17. A transverse electric field E from the second electrode 12 toward an edge portion of the first electrode 14 is generated in the second region PB. The second electrode 12 forms the electric field E together with the first electrode 14 therebetween. The electric field E flows through the insulating film 13, the first liquid crystal alignment film 15, and the liquid crystals 30, and reaches the first electrode 14. The electric field E aligns the liquid crystals 30 in a direction different from the initial alignment direction.

In the present embodiment, the first electrode 14 is a pixel electrode, and the second electrode 12 is a common electrode as illustrated in FIG. 2. However, the arrangement of the electrodes is not limited to this example. The arrangement may be such that the first electrode 14 is the common electrode and the second electrode 12 is the pixel electrode. A region in which one pixel electrode and the common electrode control the orientation of the liquid crystals 30 serves as one sub-pixel PX. A plurality of such sub-pixels PX are arranged in a matrix to form a display area.

As illustrated in FIG. 1, the first and second electrodes 14 and 12 are provided so as to partially overlap each other in the sub-pixel PX. The first electrode 14 has a longitudinal direction in the direction of extension of the image signal line 118. The second electrode 12 is provided in a strip-like shape along the direction of extension of the scanning line 116 so as to cross over a plurality of such first electrodes 14 arranged in the direction of extension of the scanning line 116.

The first electrode 14 includes a plurality of strip-like electrode portions 14a, a first connecting portion 14b1, a second connecting portion 14b2, and a contact portion 14c. Each of the strip-like electrode portions 14a extends in the direction of extension of the image signal line 118. The strip-like electrode portions 14a are provided so as to be arranged in the direction of extension of the scanning line 116. The first connecting portion 14b1 connects together one-side ends of the strip-like electrode portions 14a. The second connecting portion 14b2 connects together the other-side ends of the strip-like electrode portions 14a. The contact portion 14c branches from the first connecting portion 14b1 toward the scanning line 116. The contact portion 14c is electrically coupled to the drain electrode 119 of the thin-film transistor SW via a contact hole H3 at a location beyond the scanning line 116.

The scanning lines 116 and the image signal lines 118 are provided along gaps between the first electrodes 14. The scanning line 116 includes a main line portion 116a extending in a direction intersecting the image signal line 118 and branch portions 116b branching from the main line portion 116a in a direction parallel to the image signal lines 118. The thin-film transistor SW is provided in the vicinity of an intersection between the scanning line 116 and the image signal line 118.

The thin-film transistor SW includes the semiconductor layer 114. One end of the semiconductor layer 114 is provided at a location overlapping the image signal line 118. This end of the semiconductor layer 114 is electrically coupled to the image signal line 118 via a contact hole H1. The portion in the image signal line 118 electrically coupled with the semiconductor layer 114 serves as a source electrode 118a (refer to FIG. 2) of the thin-film transistor SW.

The semiconductor layer 114 bends in an L-shape from the location overlapping the image signal line 118, and extends along the image signal line 118 toward the scanning line 116. The semiconductor layer 114 bends into a direction parallel to the scanning line 116 at a location beyond the scanning line 116, and extends to a location beyond each of the branch portions 116b. The other end of the semiconductor layer 114 is electrically coupled to the drain electrode 119 via a contact hole H2 at a location beyond the branch portion 116b.

The semiconductor layer 114 intersects the main line portion 116a and the branch portion 116b. The portion in the main line portion 116a intersecting the semiconductor layer 114 serves as a first gate electrode 116c (refer to FIG. 2) of the thin-film transistor SW. The portion in the branch portion 116b intersecting the semiconductor layer 114 serves as a second gate electrode 116d (refer to FIG. 2) of the thin-film transistor SW. The light shielding layer 112 is provided on the lower layer side of the semiconductor layer 114. The light shielding layer 112 includes a first light shielding layer 112a provided at a location facing the first gate electrode 116c and a second light shielding layer 112b provided at a location facing the second gate electrode 116d.

FIG. 4 is an equivalent circuit diagram between the first and second electrodes 14 and 12. In FIG. 4, Symbol C_IS represents the capacitance of the insulating film 13; Symbol C_PI represents the capacitance of the first liquid crystal alignment film 15; and Symbol C_LC represents the capacitance of the liquid crystals 30. These capacitance components are provided in series between the first and second electrodes 14 and 12. A voltage applied between the first and second electrodes 14 and 12 is divided at a capacitance ratio of these capacitance components. Consequently, a variation in the capacitance (film thickness) of the first liquid crystal alignment film 15 varies a voltage V_PI applied to the first liquid crystal alignment film 15, and along with that, varies a voltage V_LC applied to the liquid crystals 30.

Each of the capacitance components varies with the material and the film thickness of the insulating film. Specifically, the capacitance is proportional to the relative permittivity of the insulating film, and inversely proportional to the film thickness thereof. In other words, the capacitance increases with increase in the relative permittivity of the insulating film, and decreases with increase in the film thickness thereof.

In the present invention, the liquid crystal display device 100 is driven in the low-frequency driving mode as described above, so that the image for pixels is refreshed at a much smaller number of times per unit time than in the case of the normal frequency driving mode. This can result in lower power consumption, but makes it difficult to maintain the liquid crystals 30 at a desired voltage level. Hence, phenomena, such as streaks in the display image, may occur to deteriorate the display quality. This problem can be effectively prevented by increasing the capacitance of the capacitive element 17.

To increase the capacitance of the capacitive element 17, the insulating film 13 is preferably formed of a material having high relative permittivity. For example, the relative permittivity of the insulating film 13 is preferably higher than 9. However, forming the insulating film 13 of a material having high relative permittivity reduces a voltage V_IS applied to the insulating film 13. Consequently, the voltage applied between the first and second electrodes 14 and 12 is substantially divided into those of the liquid crystals 30 and the first liquid crystal alignment film 15. In this case, the voltage V_LC applied to the liquid crystals 30 greatly varies with the variation in the film thickness of the first liquid crystal alignment film 15, and thus may cause unevenness in display.

For that reason, in the present embodiment, the capacity of the insulating film 13 in the second region PB is set smaller to reduce the voltages applied to the first liquid crystal alignment film 15 and the liquid crystals 30. Reducing the voltages applied to the first liquid crystal alignment film 15 and the liquid crystals 30 makes the voltage V_LC applied to the liquid crystals 30 less likely to greatly vary with the variation in the film thickness of the first liquid crystal alignment film 15.

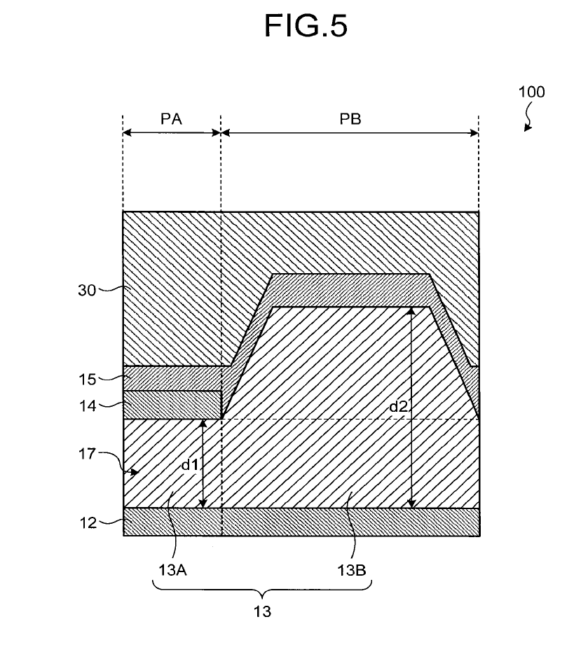

FIG. 5 is a sectional view illustrating an example of the configuration of the insulating film 13. The insulating film 13 includes a first insulating film 13A formed between the first and second electrodes 14 and 12, and also includes a second insulating film 13B formed between the first liquid crystal alignment film 15 and the second electrode 12. The second insulating film 13B is formed so as not to overlap the first electrode 14. Letting d1 denote the film thickness of the first insulating film 13A, ∈1 denote the relative permittivity of the material of the first insulating film 13A, d2 denote the film thickness of the second insulating film 13B, and ∈2 denote the relative permittivity of the material of the second insulating film 13B, the liquid crystal display device 100 satisfies the following expressions (1) and (2).

9<∈1<65 (1)

∈1/d1>∈2/d2 (2)

The film thickness d1 represents the film thickness of a constant thickness part in the central portion of the first region PA. The film thickness d2 represents the film thickness of a constant thickness part in the central portion of the second region PB. The film thicknesses are measured using, for example, a high-speed spectroscopic ellipsometer M2000 (trademark) manufactured by J.A. Woollam Japan Co., Inc.

The relative permittivity ∈1 represents the relative permittivity of a single material if the single material forms the first insulating film 13A, or represents an average relative permittivity value of a plurality of materials if the materials form the first insulating film 13A. That is, assuming that a capacitor is formed by interposing the first insulating film 13A between a pair of electrodes, ∈1/d1 represents the capacitance per unit area of the first insulating film 13A, and the relative permittivity ∈1 represents a value obtained by multiplying the capacitance per unit area of the first insulating film 13A by the film thickness d1. The same applies to ∈2/d2 and the relative permittivity ∈2. The relative permittivity values ∈1 and ∈2 are measured at a measuring frequency of 1 MHz using a measuring device (product name: 4284A Precision LCR Meter) manufactured by Hewlett-Packard Company in a measurement environment of at 25° C. and 50% relative humidity.

In the present embodiment, for example, the film thickness d2 of the second insulating film 13B is larger than the film thickness d1 of the first insulating film 13A. As a result, the capacitance per unit area of the second insulating film 13B is smaller than the capacitance per unit area of the first insulating film 13A. The film thickness d1 of the first insulating film 13A and the film thickness d2 of the second insulating film 13B are, for example, 150 nm to 450 nm, and preferably 150 nm to 350 nm. The second insulating film 13B is formed so as to project higher than the first insulating film 13A toward the liquid crystals 30. The second insulating film 13B projects higher, by, for example, 200 nm or smaller, than the first insulating film 13A toward the liquid crystals 30. This configuration restrains the transmittance of the liquid crystal display device 100 from decreasing.

Each of the first and second insulating films 13A and 13B is formed of a material having a high relative permittivity value. The relative permittivity values ∈1 and ∈2 of the first and second insulating films 13A and 13B are higher than 9 and lower than 65, preferably 15 to 40, and more preferably 15 to 30. The first and second insulating films 13A and 13B are formed of, for example, the same material. The material of the first and second insulating films 13A and 13B is composed of, for example, one type or two or more types of materials selected from the group consisting of ZrSiO₄, TiO₂, SrTiO₃, MgO, ZrO₂, Al₂O₃, Y₂O₃, and HfO₂. The material of the first and second insulating films 13A and 13B is preferably a mixture of two or more types of materials selected from the group consisting of ZrSiO₄, TiO₂, SrTiO₃, MgO, ZrO₂, Al₂O₃, Y₂O₃, and HfO₂.

A specific resistance ρ of the first and second insulating films 13A and 13B is preferably set to a relatively large value as follows: 1.0×10⁷≦ρ≦1.0×10¹² (Ω·m). This setting provides a higher insulation performance of the first and second insulating films 13A and 13B, so that abnormal display caused by leakage between electrodes is less likely to occur. Specifically, the first and second insulating films 13A and 13B preferably employ a material having a band gap of 3 or larger, and more preferably 4 or larger.

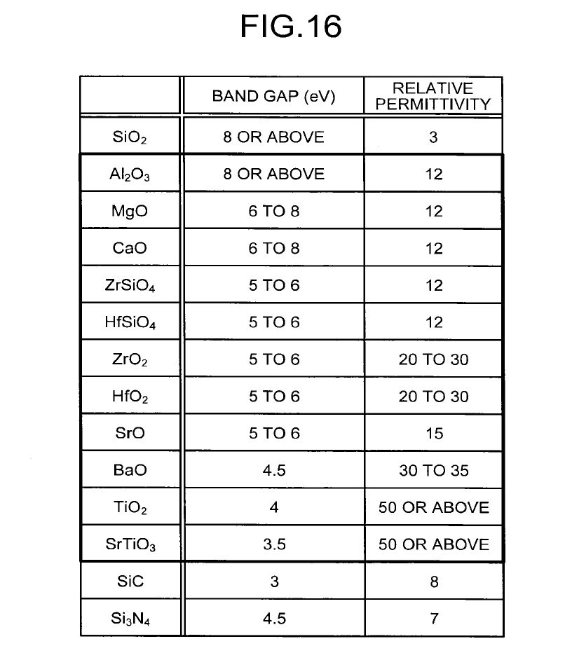

FIG. 16 is a diagram illustrating approximate values of relative permittivity ∈ and band gaps of various materials. In the present embodiment, the first and second insulating films 13A and 13B employ materials having a specific resistance of 9 or larger and a band gap of 3 or larger among the materials illustrated in FIG. 16.

While the producing method of the insulating film 13 is not limited, the following methods are used to form the insulating film 13. First, a first high-permittivity layer is selectively formed in the second region PB. In this case, the first high-permittivity layer has a thickness of, for example, 200 nm. Then, a second high-permittivity layer is formed in the first and second regions PA and PB so as to cover the first high-permittivity layer. In another producing method, the first high-permittivity layer is first selectively formed in the first and second regions PA and PB. Then, the second high-permittivity layer is formed in the second region PB so as to cover the first high-permittivity layer. In this producing method, the second high-permittivity layer has a thickness of, for example, 200 nm. In the above-described manner, the first insulating film 13A containing a high-permittivity material is formed in the first region PA, and the second insulating film 13B containing a high-permittivity material is formed in the second region PB.

In the description of the present invention including the other embodiments, each of the high-permittivity materials constituting the high-permittivity layers has a relative permittivity value of higher than 9 and lower than 65. A low-permittivity material constituting a low-permittivity layer (to be described later) has a relative permittivity value of 9 or lower. The first and second high-permittivity layers may be simultaneously produced in one process. Moreover, the second high-permittivity material constituting the second high-permittivity layer may be the same as or different from the first high-permittivity material constituting the first high-permittivity layer.

After the insulating film 13 is formed, the first electrode 14 is formed on the first insulating film 13A. The first electrode 14 is formed of a translucent conductive material, such as indium tin oxide (ITO). The first electrode 14 has a thickness of, for example, 30 nm to 100 nm.

In the liquid crystal display device 100 of the present embodiment described above, the film thickness of the second insulating film 13B is larger than that of the first insulating film 13A. This results in a smaller capacitance value per unit area of the second insulating film 13B than that of the first insulating film 13A. This, in turn, can restrain the liquid crystal application voltage V_LC from varying with the variation in the film thickness of the first liquid crystal alignment film 15 while increasing the capacitance of the capacitive element 17. Thus, good images can be displayed even when the liquid crystals 30 are driven at a low frequency.

### Second Embodiment

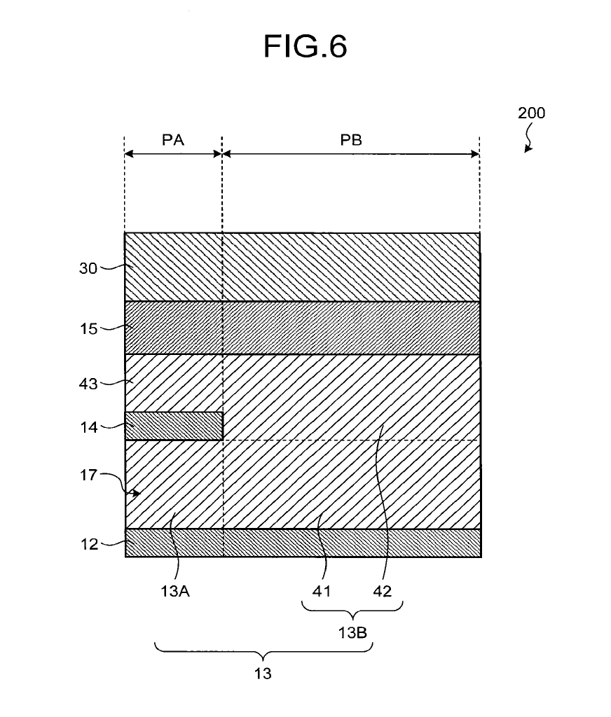

FIG. 6 is a sectional view of a liquid crystal display device 200 according to a second embodiment of the present invention. In the present embodiment, components common to those of the first embodiment are given the same reference numerals, and the detailed description thereof will not be repeated.

The present embodiment differs from the first embodiment in that a third insulating film 43 is formed between the first electrode 14 and the first liquid crystal alignment film 15. This configuration makes a large height difference difficult to be formed between the second insulating film 13B and the third insulating film 43. As a result, the orientation of the liquid crystals 30 is difficult to be disturbed in a boundary region between the first and second regions PA and PB.

The insulating film 13 and the third insulating film 43 are formed using, for example, the following method. First, the first high-permittivity layer is formed in the first and second regions PA and PB. The first high-permittivity layer has a thickness of, for example, 200 nm. This process forms the first insulating film 13A containing the first high-permittivity material in the first region PA, and forms a first insulating layer 41 containing the first high-permittivity material in the second region PB. The first insulating layer 41 constitutes a part (insulating layer on the second electrode 12 side) of the second insulating film 13B.

Then, the first electrode 14 is formed on the first high-permittivity layer. The first electrode 14 has a thickness of, for example, 50 nm.

Then, the second high-permittivity layer is formed in the first and second regions PA and PB so as to cover the first electrode 14. The second high-permittivity layer has a thickness of, for example, 200 nm. This process forms the third insulating film 43 containing the second high-permittivity material in the first region PA, and forms a second insulating layer 42 containing the second high-permittivity material in the second region PB. The second insulating layer 42 constitutes a part of the second insulating film 13B (insulating layer facing the liquid crystals 30).

Also in the liquid crystal display device 200 of the present embodiment described above, the liquid crystal application voltage V_LC can be restrained from varying with the variation in the film thickness of the first liquid crystal alignment film 15 while the capacitance of the capacitive element 17 increases. In the present embodiment, the height difference in the boundary region between the first and second regions PA and PB is reduced, so that the orientation of the liquid crystals 30 is difficult to be disturbed, and hence the liquid crystal display device with excellent display quality can be obtained.

### Third Embodiment

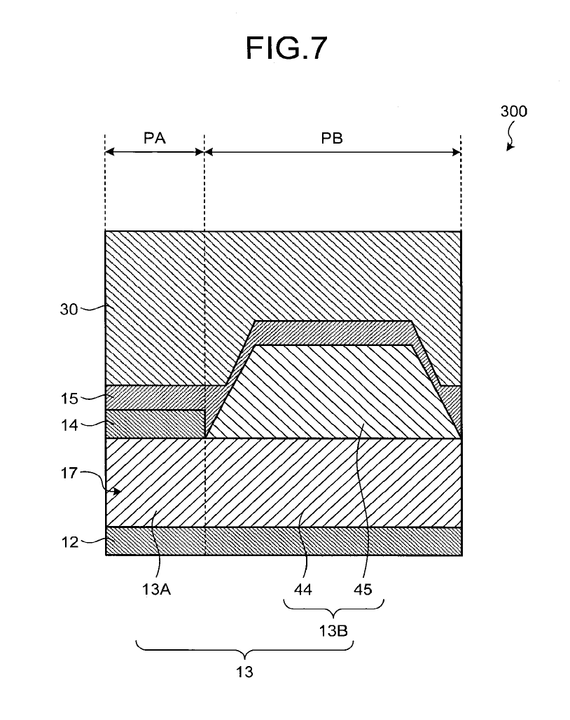

FIG. 7 is a sectional view of a liquid crystal display device 300 according to a third embodiment of the present invention. In the present embodiment, components common to those of the first embodiment are given the same reference numerals, and the detailed description thereof will not be repeated.

The present embodiment differs from the first embodiment in that the second insulating film 13B is a laminated body of a plurality of insulating layers having greatly different relative permittivity values. The second insulating film 13B includes, for example, a first insulating layer 44 and a second insulating layer 45. The adjacent insulating layers differ from each other in material. For example, the first insulating layer 44 is formed of a high-permittivity material, and the second insulating layer 45 is formed of a low-permittivity material (such as SiN).

In the present embodiment, for example, the film thickness of the second insulating film 13B is larger than that of the first insulating film 13A. The second insulating film 13B is formed so as to project higher than the first insulating film 13A toward the liquid crystals 30. A portion of the second insulating film 13B projecting higher than the first insulating film 13A toward the liquid crystals 30 serves as the second insulating layer 45. The second insulating film 13B projects higher, by a height (thickness of the second insulating layer 45) of, for example, 200 nm or smaller, than the first insulating film 13A toward the liquid crystals 30. This configuration restrains the transmittance of the liquid crystal display device 300 from decreasing.

The insulating film 13 is formed using, for example, the following method. First, a high-permittivity layer is formed in the first and second regions PA and PB. The high-permittivity layer has a thickness of, for example, 200 nm. This process forms the first insulating film 13A containing the high-permittivity material in the first region PA, and forms the first insulating layer 44 containing the high-permittivity material in the second region PB. Then, the low-permittivity layer is selectively formed in the second region PB. The low-permittivity layer has a thickness of, for example, 200 nm. This process forms the second insulating layer 45 containing the low-permittivity material in the second region PB.

Also in the liquid crystal display device 300 of the present embodiment described above, the film thickness of the second insulating film 13B is larger than that of the first insulating film 13A. This, in turn, can restrain the liquid crystal application voltage V_LC from varying with the variation in the film thickness of the first liquid crystal alignment film 15 while increasing the capacitance of the capacitive element 17. In the present embodiment, the portion of the second insulating film 13B projecting higher than the first insulating film 13A toward the liquid crystals 30 is formed of the low-permittivity material. This configuration more effectively restrains the liquid crystal application voltage V_LC from varying with the variation in the film thickness of the first liquid crystal alignment film 15, so that good images can be displayed even when the liquid crystals 30 are driven at a low frequency.

### Fourth Embodiment

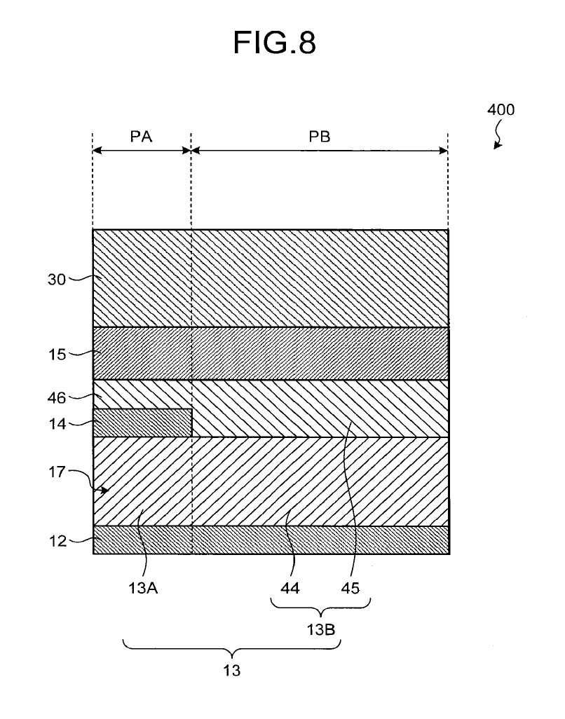

FIG. 8 is a sectional view of a liquid crystal display device 400 according to a fourth embodiment of the present invention. In the present embodiment, components common to those of the third embodiment are given the same reference numerals, and the detailed description thereof will not be repeated.

The present embodiment differs from the third embodiment in that a third insulating film 46 is formed between the first electrode 14 and the first liquid crystal alignment film 15. This configuration makes a large height difference difficult to be formed between the second insulating film 13B and the third insulating film 46. As a result, the orientation of the liquid crystals 30 is difficult to be disturbed in the boundary region between the first and second regions PA and PB.

The insulating film 13 and the third insulating film 46 are formed using, for example, the following method. First, the high-permittivity layer is formed in the first and second regions PA and PB. The high-permittivity layer has a thickness of, for example, 200 nm. This process forms the first insulating film 13A containing the high-permittivity material in the first region PA, and forms the first insulating layer 44 containing the high-permittivity material in the second region PB.

Then, the first electrode 14 is formed on the high-permittivity layer. The first electrode 14 has a thickness of, for example, 50 nm.

Then, the low-permittivity layer is formed in the first and second regions PA and PB so as to cover the first electrode 14. The low-permittivity layer has a thickness of, for example, 200 nm. This process forms the third insulating film 46 containing the low-permittivity material in the first region PA, and forms the second insulating layer 45 containing the low-permittivity material in the second region PB.

Also in the liquid crystal display device 400 of the present embodiment described above, the capacitance of the second insulating film 13B decreases while the capacitance of the capacitive element 17 increases. As a result, the liquid crystal application voltage V_LC can be restrained from varying with the variation in the film thickness of the first liquid crystal alignment film 15. In the present embodiment, the orientation of the liquid crystals 30 is difficult to be disturbed in the boundary region between the first and second regions PA and PB, so that the liquid crystal display device with excellent display quality can be obtained.

### Fifth Embodiment

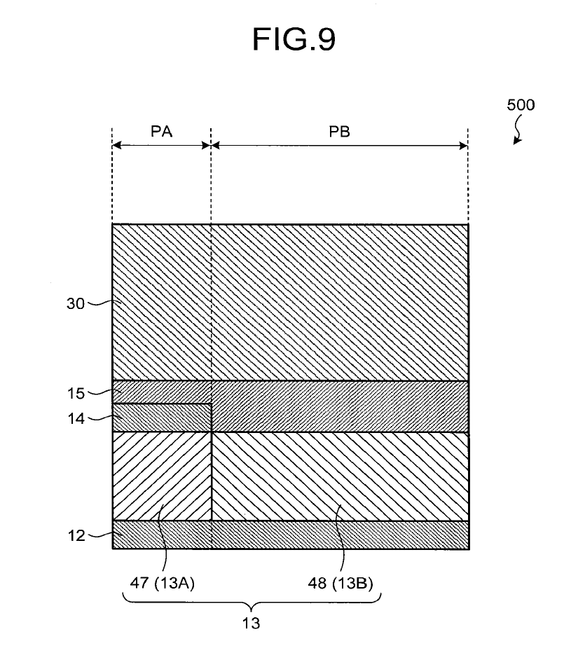

FIG. 9 is a sectional view of a liquid crystal display device 500 according to a fifth embodiment of the present invention. In the present embodiment, components common to those of the first embodiment are given the same reference numerals, and the detailed description thereof will not be repeated.

The present embodiment differs from the first embodiment in that the insulating film 13 includes a first layer 47 and a second layer 48 formed of materials different from each other, and that the insulating film 13 is formed by arranging the first and second layers 47 and 48 in a direction orthogonal to the width direction of the insulating film 13. The first layer 47 is the high-permittivity layer formed of the high-permittivity material. The second layer 48 is, for example, the low-permittivity layer formed of the low-permittivity material. The first electrode 14 is formed on the first layer 47, but is not formed on the second layer 48. The first and second layers 47 and 48 have substantially the same thickness.

In the liquid crystal display device 500 of the present embodiment described above, the second layer 48 (second insulating film 13B) is formed of the low-permittivity material. As a result, the liquid crystal application voltage V_LC can be restrained from varying with the variation in the film thickness of the first liquid crystal alignment film 15 while the capacitance of the capacitive element 17 increases. Thus, good images can be displayed even when the liquid crystals 30 are driven at a low frequency.

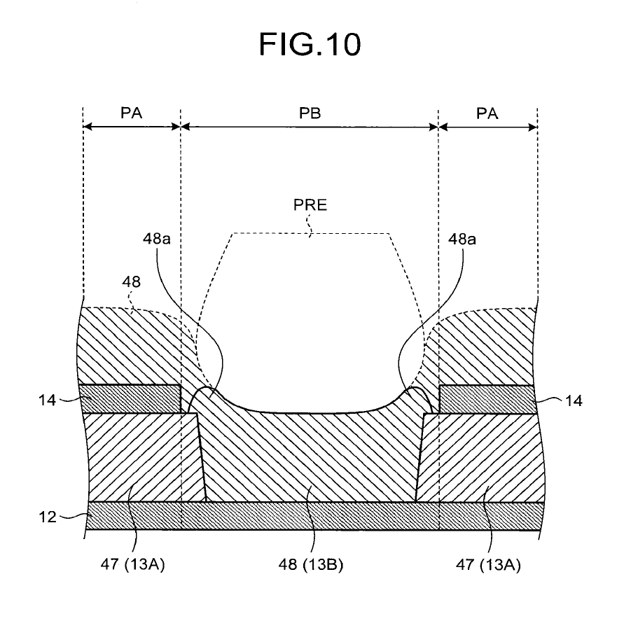

FIG. 10 is a diagram for explaining a preferable method for forming the insulating film 13 of the fifth embodiment. First, the first layer 47 is formed on the second electrode 12. The first layer 47 has a thickness of, for example, 200 nm. The first layer 47 is formed slightly larger than the first region PA so that an edge portion of the first layer 47 is located in the second region PB. The first layer 47 located in the first region PA serves as the first insulating film 13A. Then, the second layer 48 is formed in the first and second regions PA and PB so as to cover the first layer 47. The second layer 48 has a thickness of, for example, 200 nm. Then, the second layer 48 is etched using a photoresist PRE to form the second insulating film 13B containing the low-permittivity material in the second region PB. In the above-described manner, the insulating film 13 is formed.

The second layer 48 is formed so as to cover the side and upper surfaces of the first layer 47. As a result, when the second layer 48 is etched, an edge portion 48a of the second layer 48 is placed so as to lie on top of the edge portion of the first layer 47. This process arranges the first and second layers 47 and 48 so as to overlap each other at the edge portions thereof. The edge portion 48a of the second layer 48 is placed so as to project toward the liquid crystals 30. Hence, if the first electrode 14 is formed on top of the edge portion 48a of the second layer 48, the electric field for aligning the liquid crystals 30 may be disturbed. For this reason, in the present embodiment, the first electrode 14 is formed to have a smaller width than that of the first layer 47 so as to be formed in a position on the first layer 47 not overlapping the edge portion 48a of the second layer 48. The first electrode 14 is more preferably formed to have an area smaller than that of the first layer 47.

Also in the liquid crystal display device 500 of the present embodiment described above, the liquid crystal application voltage V_LC can be restrained from varying with the variation in the film thickness of the first liquid crystal alignment film 15 while the capacitance of the capacitive element 17 increases. Thus, higher-quality images can be displayed.

### Sixth Embodiment

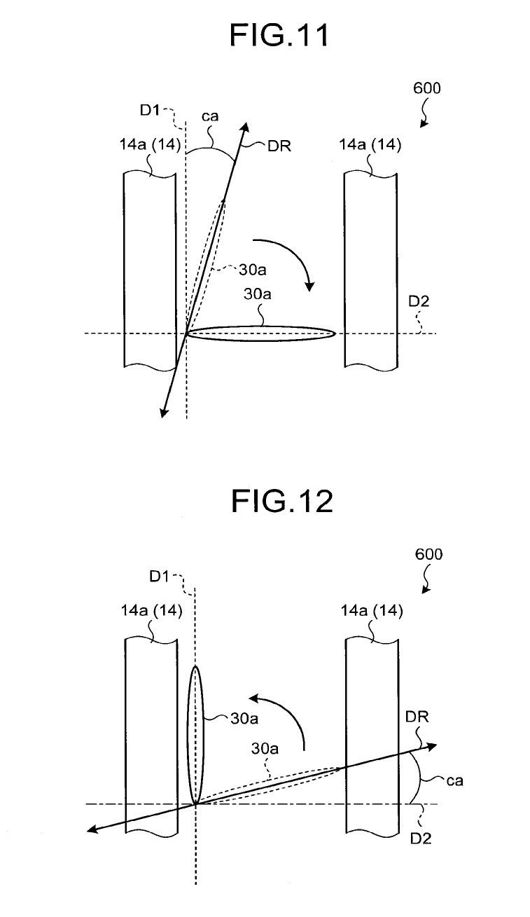

FIGS. 11 and 12 are diagrams for explaining a liquid crystal display device 600 according to a sixth embodiment of the present invention. In the present embodiment, components common to those of the first embodiment are given the same reference numerals, and the detailed description thereof will not be repeated.

The present embodiment differs from the first embodiment in that the chevron angle of the liquid crystals is adjusted to reduce the variation in the liquid crystal application voltage V_LC caused by the variation in the film thickness of the first liquid crystal alignment film (refer to FIG. 3). Letting ca denote the chevron angle of the liquid crystals, the liquid crystal display device 600 of the present embodiment satisfies the following expression (3).

10°<ca (3)

FIG. 11 is a diagram illustrating the chevron angle ca when a positive liquid crystal material is used as the liquid crystals. FIG. 12 is a diagram illustrating the chevron angle ca when a negative liquid crystal material is used as the liquid crystals. As illustrated in FIGS. 11 and 12, the first electrode 14 includes one or more of the strip-like electrode portions 14a. The direction of extension of the strip-like electrode portion 14a is referred to as a first direction D1, and a direction orthogonal to the first direction D1 is referred to as a second direction D2. As illustrated in FIG. 11, when the positive liquid crystal material is used as the liquid crystals, the chevron angle ca is defined as the angle formed between the first direction D1 and an initial alignment direction DR. As illustrated in FIG. 12, when the negative liquid crystal material is used as the liquid crystals, the chevron angle ca is defined as the angle formed between the second direction D2 and the initial alignment direction DR.

The following method is used to measure the chevron angle ca. First, a microscope is used to measure the direction of extension of the strip-like electrode portion 14a. Then, the liquid crystal display device with neither the first polarizing plate 16 nor the second polarizing plate 23 bonded thereto is placed between a polarizer and an analyzer disposed in a cross Nicol arrangement. Then, the liquid crystal display device is rotated with no voltage applied between the first electrode 14 and the second electrode 12, and the light quantity of light passing through the analyzer is measured. The light quantity is minimized when the liquid crystal molecules are arranged in the direction of the transmission axis of the polarizer or the analyzer, so that the direction of the transmission axis of the polarizer or the analyzer at the time of the minimum light quantity is detected as the initial alignment direction DR.

Letting θ1 denote the angle between the direction of the transmission axis of the polarizer and the direction of extension of the strip-like electrode portion 14a, and letting θ2 denote the angle between the direction of the transmission axis of the analyzer and the direction of extension of the strip-like electrode portion 14a, the angle θ1 or θ2 is obtained as the chevron angle ca. Too large chevron angle ca darkens the display, so that the chevron angle ca is set to a smaller value. Consequently, one of the angles θ1 and θ2 that is smaller than 45 degrees is detected as the chevron angle ca.

Changing the chevron angle ca changes the amount of change in orientation of a liquid crystal molecule 30a caused when the voltage is applied between the first electrode 14 and the second electrode 12 (refer to FIG. 3). For example, when the positive liquid crystal material is used as the liquid crystals, the alignment direction of the liquid crystal molecule 30a changes from the initial alignment direction DR to the second direction D2 as illustrated in FIG. 11, and, when the negative liquid crystal material is used as the liquid crystals, the alignment direction of the liquid crystal molecule 30a changes from the initial alignment direction DR to the first direction D1 as illustrated in FIG. 12. The chevron angle ca can be understood as an angle between the initial alignment direction DR and a direction orthogonal to the alignment direction of the liquid crystal molecule 30a formed when the voltage is applied. The amount of change in orientation of the liquid crystal molecule 30a increases with decrease in the chevron angle ca.

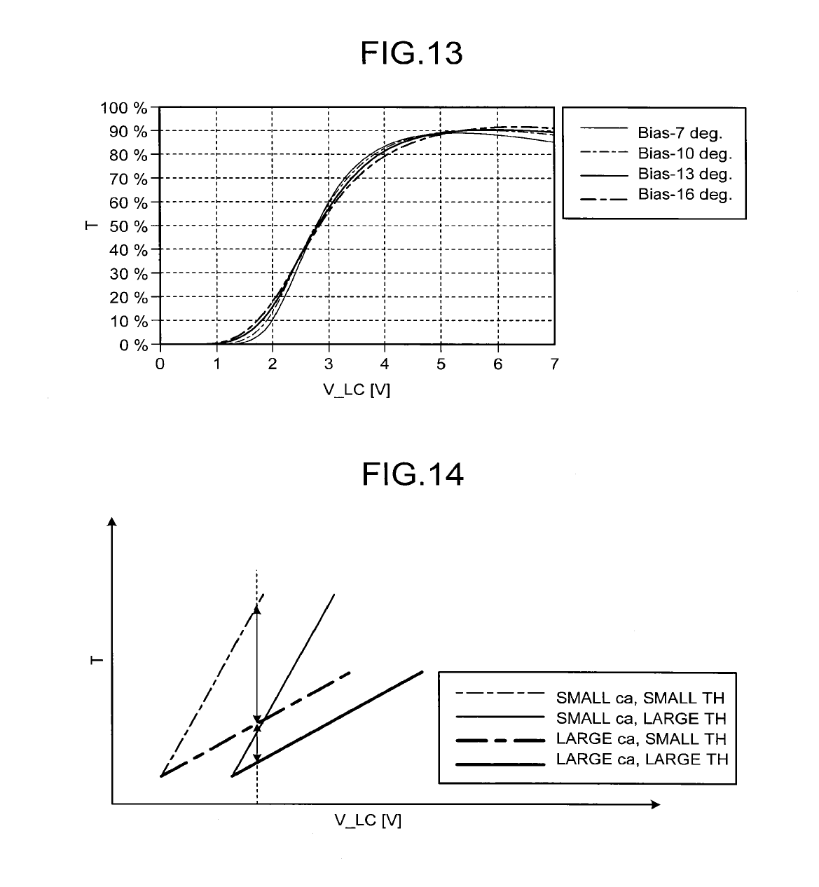

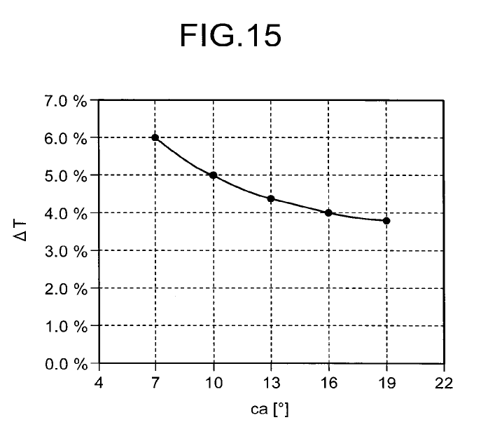

The behavior of the liquid crystal molecule 30a affects the transmittance of the liquid crystal display device 600. FIG. 13 is a diagram illustrating a relation between the voltage V_LC applied to liquid crystals and transmittance T thereof (V-T curve). FIG. 14 is a diagram illustrating changes in the V-T curve caused by changes in a film thickness TH of the first liquid crystal alignment film 15 (refer to FIG. 3) and in the chevron angle ca. FIG. 15 is a diagram illustrating a relation between a change amount ΔT of the transmittance T caused by a film thickness variation (by an amount of 5 nm) in the first liquid crystal alignment film and the chevron angle ca.

As illustrated in FIGS. 13 and 14, reducing the chevron angle ca increases the gradient of the V-T curve, while increasing the chevron angle ca reduces the gradient of the V-T curve; and reducing the film thickness TH of the first liquid crystal alignment film shifts the V-T curve toward the low-voltage side (leftward in FIG. 14), while increasing the film thickness TH of the first liquid crystal alignment film shifts the V-T curve toward the high-voltage side (rightward in FIG. 14). Consequently, as illustrated in FIG. 15, increasing the chevron angle ca reduces the change amount ΔT of the transmittance caused by the film thickness variation in the first liquid crystal alignment film.

When the change amount ΔT of the transmittance exceeds 5%, a viewer may notice the change in the transmittance as a change in brightness of the display. For this reason, the change amount ΔT of the transmittance is preferably kept at 5% or lower. FIG. 15 indicates that the change amount ΔT of the transmittance is 5% when the chevron angle ca is in the neighborhood of 10 degrees. Accordingly, to keep the change amount ΔT of the transmittance at 5% or lower, the chevron angle ca is preferably larger than 10 degrees. However, increasing the chevron angle ca reduces the transmittance T, and thereby darkens the display. Consequently, so as to keep the transmittance T within a practical range, the chevron angle ca is preferably 45 degrees or smaller, more preferably 30 degrees or smaller, and still more preferably 20 degrees or smaller.

Also in the liquid crystal display device 600 of the present embodiment described above, the liquid crystal application voltage V_LC can be restrained from varying with the variation in the film thickness of the first liquid crystal alignment film while the capacitance of the capacitive element 17 (refer to FIG. 3) increases. The present embodiment can obtain the effect described above by only changing the chevron angle ca. This feature minimizes modifications in the production process.

### Experimental Examples

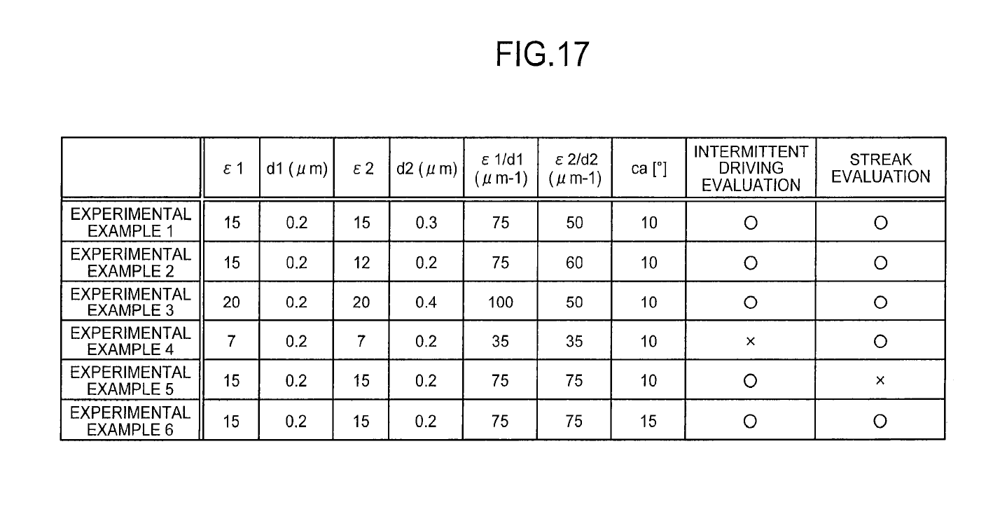

FIG. 17 is a diagram illustrating experimental examples concerning an intermittent driving evaluation and a streak evaluation.

The intermittent driving evaluation evaluates whether an image flickers when a liquid crystal display device is intermittently driven at a frequency of 30 Hz or lower. The symbol “◯” indicates that no flickers are noticed, and the symbol “X” indicates that flickers are noticed. The streak evaluation evaluates whether a streak is visible in the image when the liquid crystal display device is driven at a frequency of 60 Hz. The symbol “◯” indicates that the streak is invisible or unnoticed, and the symbol “X” indicates that the streak is visible or noticed.

Experimental Example 1 represents the results for a liquid crystal display device having the structure of the first embodiment. Experimental Example 2 represents the results for a liquid crystal display device having the structure of the fifth embodiment. Experimental Example 3 represents the results for a liquid crystal display device having the structure of the first embodiment. In the Experimental Example 3, the first and second insulating films 13A and 13B have relative permittivity values higher than those of Experimental Example 1 and the second insulating film 13B has a thickness larger than that of the Experimental Example 1. Experimental Example 4 represents the results for a liquid crystal display device in which the first and second insulating films 13A and 13B are formed of the same low-permittivity material and formed to have the same film thickness. Experimental Example 5 represents the results for a liquid crystal display device in which the first and second insulating films 13A and 13B are formed of the same high-permittivity material and formed to have the same film thickness. Experimental Example 6 represents the results for a liquid crystal display device in which the first and second insulating films 13A and 13B are formed of the same high-permittivity material and formed to have the same film thickness. In the Experimental Example 6, the chevron angle ca is set larger as in the structure of the sixth embodiment. The negative liquid crystal material was used for all the experimental examples.

As illustrated in FIG. 17, all Experimental Examples 1 to 3 satisfy expressions (1) and (2). In all these cases, the results of the intermittent driving evaluation and the streak evaluation are “◯”. Experimental Example 4 satisfies neither of expressions (1) and (2). In this case, the result of the streak evaluation is “◯”, and the result of the intermittent driving evaluation is “X”. Experimental Example 5 satisfies expression (1), but does not satisfy expression (2). In this case, the result of the intermittent driving evaluation is “◯”, and the result of the streak evaluation is “X”. Experimental Example 6 satisfies expression (1), but does not satisfy expression (2). Experimental Example 6, however, satisfies expression (3). In this case, the results of both the intermittent driving evaluation and the streak evaluation are “◯”. The above results show that all the structures that satisfy expression (1) and either one of expressions (2) and (3) lead to good results of both the intermittent driving evaluation and the streak evaluation.

While the preferred embodiments of the present invention have been described above, the present invention is not limited to such embodiments. The description disclosed in the embodiments is merely an example, and various modifications can be made without departing from the gist of the present invention. Appropriate modifications made without departing from the gist of the present invention naturally belong to the technical scope of the present invention.

What is claimed is:

1. A liquid crystal display device comprising:
an insulating base substrate;
an insulating film formed on the insulating base substrate;
a first electrode;
a second electrode that forms an electric field together with the first electrode therebetween;
liquid crystals; and
a liquid crystal alignment film that aligns the liquid crystals, wherein
the insulating film comprises a first insulating film formed between the first and second electrodes, and a second insulating film formed between the liquid crystal alignment film and the second electrode;
the second insulating film is formed so as not to overlap the first electrode;
the first electrode is placed closer to the liquid crystals than the second electrode; and
letting d1 denote a film thickness of the first insulating film, ∈1 denote relative permittivity of a material of the first insulating film, d2 denote a film thickness of the second insulating film, ∈2 denote relative permittivity of a material of the second insulating film, and ca denote a chevron angle of the liquid crystals, the liquid crystal display device satisfies expression (1) and either one of expressions (2) and (3) given below:
9<∈1<65 (1)
∈1/d1>∈2/d2 (2)
10°<ca (3).

2. The liquid crystal display device according to claim 1, wherein the material of the first insulating film is composed of one type or two or more types of materials selected from the group consisting of ZrSiO₄, TiO₂, SrTiO₃, MgO, ZrO₂, Al₂O₃, Y₂O₃, and HfO₂.

3. The liquid crystal display device according to claim 2, wherein the material of the first insulating film is a mixture of two or more types of materials selected from the group consisting of ZrSiO₄, TiO₂, SrTiO₃, MgO, ZrO₂, Al₂O₃, Y₂O₃, and HfO₂.

4. The liquid crystal display device according to claim 1, wherein the second insulating film is a laminated body of a plurality of insulating layers.

5. The liquid crystal display device according to claim 1, wherein the film thickness d2 of the second insulating film is larger than the film thickness d1 of the first insulating film.

6. The liquid crystal display device according to claim 1, wherein
the relative permittivity ∈2 is higher than 9 and lower than 65;
the second insulating film is formed so as to project higher than the first insulating film toward the liquid crystals; and
the second insulating film projects higher than the first insulating film by 200 nm or smaller toward the liquid crystals.

7. The liquid crystal display device according to claim 1, wherein
the liquid crystals are made of a liquid crystal material having a negative dielectric constant anisotropy value; and
the film thickness d2 of the second insulating film is 150 nm to 450 nm, and the relative permittivity ∈2 thereof is 30 or lower.

8. The liquid crystal display device according to claim 1, further comprising a third insulating film formed between the first electrode and the liquid crystal alignment film.

9. The liquid crystal display device according to claim 1, wherein
the insulating film includes a first layer and a second layer formed of materials different from each other;
the first and second layers are arranged in a direction orthogonal to a width direction of the insulating film;
the first and second layers are arranged so as to overlap each other at respective edge portions thereof; and
the first electrode is formed in a position on the first layer not overlapping the edge portion of the second layer.

10. The liquid crystal display device according to claim 1, wherein the liquid crystal display device is driven at a frequency of 30 Hz or lower.

11. The liquid crystal display device according to claim 2, wherein the second insulating film is a laminated body of a plurality of insulating layers.

12. The liquid crystal display device according to claim 3, wherein the second insulating film is a laminated body of a plurality of insulating layers.

13. The liquid crystal display device according to claim 2, wherein the film thickness d2 of the second insulating film is larger than the film thickness d1 of the first insulating film.

14. The liquid crystal display device according to claim 3, wherein the film thickness d2 of the second insulating film is larger than the film thickness d1 of the first insulating film.

15. The liquid crystal display device according to claim 4, wherein the film thickness d2 of the second insulating film is larger than the film thickness d1 of the first insulating film.

16. The liquid crystal display device according to claim 2, wherein
the relative permittivity ∈2 is higher than 9 and lower than 65;
the second insulating film is formed so as to project higher than the first insulating film toward the liquid crystals; and
the second insulating film projects higher than the first insulating film by 200 nm or smaller toward the liquid crystals.

17. The liquid crystal display device according to claim 3, wherein
the relative permittivity ∈2 is higher than 9 and lower than 65;
the second insulating film is formed so as to project higher than the first insulating film toward the liquid crystals; and
the second insulating film projects higher than the first insulating film by 200 nm or smaller toward the liquid crystals.

18. The liquid crystal display device according to claim 4, wherein
the relative permittivity ∈2 is higher than 9 and lower than 65;
the second insulating film is formed so as to project higher than the first insulating film toward the liquid crystals; and
the second insulating film projects higher than the first insulating film by 200 nm or smaller toward the liquid crystals.

19. The liquid crystal display device according to claim 5, wherein
the relative permittivity ∈2 is higher than 9 and lower than 65;
the second insulating film is formed so as to project higher than the first insulating film toward the liquid crystals; and
the second insulating film projects higher than the first insulating film by 200 nm or smaller toward the liquid crystals.

20. The liquid crystal display device according to claim 2, wherein
the liquid crystals are made of a liquid crystal material having a negative dielectric constant anisotropy value; and
the film thickness d2 of the second insulating film is 150 nm to 450 nm, and the relative permittivity ∈2 thereof is 30 or lower.
